(19) United States
(12) Patent Application Publication
(10) Pub. No.: US 2026/0089134 A1
(43) Pub. Date: Mar. 26, 2026

(54) COMMUNICATION SYSTEM, CONTROL METHOD, AND COMMUNICATION APPARATUS

(71) Applicant: CANON KABUSHIKI KAISHA, Tokyo (JP)

(72) Inventor: NAOKI SHINOZUKA, Kanagawa (JP)

(21) Appl. No.: 19/326,992

(22) Filed: Sep. 12, 2025

(30) Foreign Application Priority Data
Sep. 20, 2024 (JP) 2024-164103

(51) Int. Cl. H04L 61/301; H04L 101/622

(52) U.S. Cl. CPC H04L 61/301; H04L 2101/622

(57) ABSTRACT

A communication apparatus including: a first transmitting unit configured to transmit a MAC address of the communication apparatus at a first timing; a control unit configured to execute specific control based on a specific function that randomizes the MAC address of the communication apparatus according to a specific condition being enabled and the communication apparatus being in a specific mode for performing wireless configuration of the communication apparatus, the specific control controlling the communication apparatus to not randomize the MAC address of the communication apparatus even when the specific condition is satisfied; and a second transmitting unit configured to transmit the MAC address of the communication apparatus at a second timing after the specific control is executed.

### BACKGROUND

### Field of the Technology

The present disclosure relates to a communication system, a control method, and a communication apparatus.

### Description of the Related Art

In wireless LAN communication, if a third party is able to intercept the MAC address of a terminal used by a user, the third party may be able to track the user’s behavior or the like. Accordingly, a technique that periodically changes the MAC address of a terminal is known as a way to protect the privacy of users. Japanese Patent Laid-Open No. 2017-525287 discloses a technique in which when an information processing apparatus and a communication apparatus having a MAC address randomization function communicate, even if the MAC address of the communication apparatus is randomized partway through, the information processing apparatus identifies the communication apparatus and resumes the communication.

### SUMMARY

The present disclosure provides a technique for appropriately controlling the MAC address randomization of a communication apparatus when an information processing apparatus and a communication apparatus having a MAC address randomization function communicate.

The present disclosure in one aspect provides a communication system comprising an information processing apparatus and a communication apparatus, the communication apparatus comprising at least one memory and at least one processor which function as: a first transmitting unit configured to transmit a MAC address of the communication apparatus at a first timing; a control unit configured to execute specific control based on a specific function that randomizes the MAC address of the communication apparatus according to a specific condition being enabled and the communication apparatus being in a specific mode for performing wireless configuration of the communication apparatus, the specific control controlling the communication apparatus to not randomize the MAC address of the communication apparatus even when the specific condition is satisfied; and a second transmitting unit configured to transmit the MAC address of the communication apparatus at a second timing after the specific control is executed, and the information processing apparatus comprising at least one memory and at least one processor which function as: a third transmitting unit configured to transmit information for performing the wireless configuration of the communication apparatus over a connection between the communication apparatus in the specific mode and the information processing apparatus; and an executing unit configured to execute processing that is based on the MAC address of the communication apparatus transmitted at the first timing and the MAC address of the communication apparatus transmitted at the second timing.

Features of the present disclosure will become apparent from the following description of embodiments with reference to the attached drawings. The following description of embodiments is described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1 is a diagram illustrating an example of a system configuration.

FIG. 2 is a diagram illustrating an example of a hardware configuration.

FIGS. 3A and 3B are flowcharts illustrating an example of processing executed by a PC.

FIG. 4 is a flowchart illustrating an example of processing executed by the PC.

FIG. 5 is a flowchart illustrating an example of processing executed by the PC.

FIGS. 6A and 6B are flowcharts illustrating an example of processing executed by a printer.

FIG. 7 is a flowchart illustrating an example of processing executed by the printer.

FIGS. 8A, 8B, 8C, and 8D are diagrams illustrating examples of screens displayed in a display device of the PC.

FIG. 9 is a flowchart illustrating an example of processing executed by the PC.

FIGS. 10A and 10B are flowcharts illustrating an example of processing executed by the printer.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

Incidentally, when an information processing apparatus instructs a communication apparatus to connect to an external access point (AP) and causes the communication apparatus to connect to the AP, the information processing apparatus and the communication apparatus may communicate via the AP. In such a case, the information processing apparatus can use the MAC address of the communication apparatus to identify that the communication apparatus instructed to connect to the AP and the communication apparatus discovered through the AP are the same apparatus. However, if the communication apparatus has a MAC address randomization function, the information processing apparatus will be unable to identify the communication apparatus if the MAC address of the communication apparatus is randomized. In this respect, there is room for improvement in the past techniques.

Although the following will describe a printer as the communication apparatus in the present embodiment, the communication apparatus may be a PC, a tablet terminal, or the like. Likewise, although a PC will be described as the information processing apparatus in the present embodiment, the information processing apparatus may be a printer, a tablet terminal, or the like.

### First Embodiment

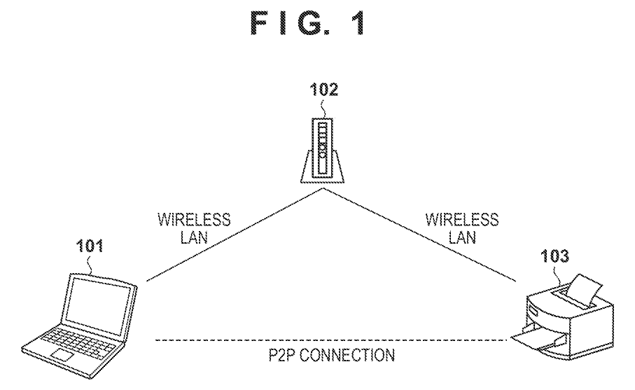

The configuration of a system according to the present disclosure will be described with reference to FIG. 1. In one example, this system is a wireless communication system in which a plurality of communication apparatuses can communicate with each other wirelessly. An information processing apparatus and a communication apparatus included in a communication system according to the present embodiment will be described hereinafter. The present embodiment will describe a PC 101 as an example of the information processing apparatus, but the information processing apparatus is not limited thereto, and a variety of devices, such as a mobile terminal, a tablet terminal, a Personal Digital Assistant (PDA), a digital camera, or the like, can be applied as the information processing apparatus. Likewise, any of a variety of devices can be applied as the communication apparatus, as long as the device is capable of communicating with the information processing apparatus wirelessly. The present embodiment will describe a printer 103 as an example of the communication apparatus. For example, the printer 103 may be an ink jet printer, a full-color laser beam printer, a black and white printer, or the like. However, the apparatus is not limited to the printer 103, and a scanner, a copier, a facsimile device, a mobile terminal, a smartphone, a laptop PC, a tablet terminal, a PDA, a digital camera, a music playback device, a television, a smart speaker, or the like can be applied as well. The device can also be a multifunction peripheral provided with a plurality of functions, such as a copying function, a fax function, a printing function, a scanner function, and the like. The present embodiment will assume that the communication apparatus is a multifunction printer having a printing function, a scanner function, and the like.

An access point 102 is an external device (an external access point) outside both the PC 101 and the printer 103. Note that the access point will be called an “AP” in the following descriptions. Specifically, the AP 102 is, for example, a device such as a wireless LAN router or the like. Note that the AP 102 is not limited to a wireless LAN router, and may be any device capable of relaying wireless communication.

The PC 101 is capable of making a wireless LAN connection with the AP 102. The printer 103 is also capable of making a wireless LAN connection with the AP 102. The PC 101 can then communicate with the printer 103 via the AP 102. The method by which the PC 101 and the printer 103 are connected via the AP 102 in this manner is generally referred to as an “infrastructure connection”. An infrastructure connection enables the construction of a network environment in which a plurality of devices can communicate with each other. The AP 102 is normally configured to be capable of Internet communication (cloud communication), and devices connected to the AP 102 can access the Internet through that communication. On the other hand, a method in which the PC 101 and the printer 103 connect directly (i.e., peer-to-peer) between those two devices only (i.e., not via the AP 102) is called a “direct connection”. The present embodiment assumes that infrastructure connections and direct connections between the PC 101 and the printer 103 are communication methods based on the IEEE 802.11 series standard. The communication method based on the IEEE 802.11 series standard is specifically Wireless Fidelity (Wi-Fi) (registered trademark).

There is also a connection method called a “wireless ad-hoc connection”, in which communication is only possible between two devices. The PC 101 and the printer 103 can also be connected directly (i.e., peer-to-peer) using a wireless ad-hoc connection. During a wireless ad-hoc connection, both the wireless interface of the PC 101 and the wireless interface of the printer 103 are used for the wireless ad-hoc connection, and thus the PC 101 and the printer 103 cannot communicate with devices other than each other. The wireless ad-hoc connection is therefore often used as a temporary connection.

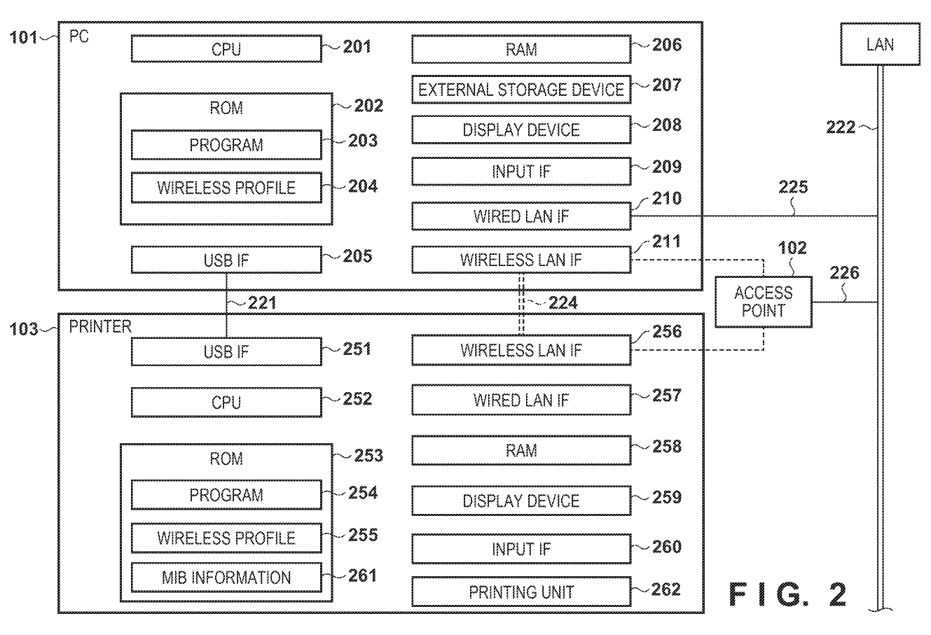

FIG. 2 illustrates the hardware configurations of the PC 101 and the printer 103 according to the present embodiment.

The PC 101 includes a CPU 201, a ROM 202, a USB interface 205, a RAM 206, an external storage device 207, a display device 208, an input interface 209, a wired LAN interface 210, a wireless LAN interface 211, and the like, which are connected over a system bus.

The CPU 201 is a system control unit including at least one processor, and controls the PC 101 as a whole. The ROM 202 stores fixed data such as control programs executed by the CPU 201, data tables, an embedded operating system (“OS”, hereinafter) program, and the like. In the present embodiment, the ROM 202 stores a wireless configuration program 203 that executes wireless configuration processing for instructing the printer 103 to configure a wireless network. The wireless configuration processing and the wireless configuration program 203 will be described in detail later. The ROM 202 also stores a wireless profile 204 and the like.

The wireless profile 204 is information including identifying information of the AP 102 (a Service Set Identifier (SSID) or the like of the AP 102) connected through the wireless LAN interface 211. The SSID is an identification name of the AP in the wireless LAN (Wi-Fi). The wireless profile 204 is information including authentication information used in authentication processing (a password of the AP 102 or the like). The wireless profile 204 is stored and managed by the CPU 201 running the OS included in the external storage device 207.

The USB interface 205, the wired LAN interface 210, and the wireless LAN interface 211 are communication interfaces that communicate data with external devices. The PC 101 can communicate with the printer 103 over a USB cable 221. The PC 101 can also communicate with the printer 103 via a P2P connection 224 made through the wireless LAN interface 211. The PC 101 can also connect to a local area network (LAN) 222 over an Ethernet cable 225 through the wired LAN interface 210. Accordingly, if the printer 103 can also be connected to the LAN 222, the PC 101 and the printer 103 can communicate with each other using the same LAN 222. Furthermore, the PC 101 can connect to the AP 102 through the wireless LAN interface 211. When the AP 102 connects to the LAN 222 over an Ethernet cable 226, the PC 101 can connect to the LAN 222. If the printer 103 can also be connected to the AP 102, the PC 101 and the printer 103 can communicate with each other via the AP 102. Although the PC 101 includes the wireless LAN interface 211, the configuration may be such that the PC 101 does not include the USB interface 205 and the wired LAN interface 210.

The RAM 206 is constituted by a Static Random Access Memory (SRAM) or the like that requires a backup power source. Note that the RAM 206 holds data in a primary battery for data backup (not shown), and can therefore store important data such as program control variables in a non-volatile state. A memory area for storing configuration information of the PC 101, management data of the PC 101, and the like is also provided in the RAM 206. The RAM 206 is used as a main memory and a working memory for the CPU 201.

The external storage device 207 is, for example, a storage device such as a hard disk drive (HDD), a solid-state drive (SSD), or the like, and stores application programs, an operating system (OS), drivers for the printer 103, and other types of data.

The display device 208 displays data, various types of information such as notifications of the state of the PC 101, and the like through a user interface screen or the like, and is constituted by a liquid crystal panel (LCD), light-emitting diodes (LEDs), or the like, for example.

The input interface 209 is an interface for accepting data inputs, operational instructions, and the like from a user, and is constituted by a physical keyboard, buttons, a touch panel, or the like. Note that the display device 208 mentioned above and the input interface 209 may be the same configuration, with screen outputs and accepting operations by the user being implemented by the same configuration.

The printer 103 includes a USB interface 251, a CPU 252, a ROM 253, a wireless LAN interface 256, a wired LAN interface 257, a RAM 258, a display device 259, an input interface 260, a printing unit 262, and the like, which are connected over a system bus.

The USB interface 251, the wired LAN interface 257, and the wireless LAN interface 256 are communication interfaces that communicate data with external devices. The printer 103 can communicate with the PC 101 over a USB interface 251. The printer 103 can also communicate with the PC 101 via the P2P connection 224 made through the wireless LAN interface 256. Additionally, the printer 103 can connect to the AP 102 through the wireless LAN interface 256. When the AP 102 connects to the LAN 222 over an Ethernet cable 226, the printer 103 can connect to the LAN 222.

The CPU 252 is a system control unit including at least one processor, and controls the printer 103 as a whole. The ROM 253 stores control programs executed by the CPU 252, embedded OS programs, and the like. In the present embodiment, a program 254, a wireless profile 255, management information base (MIB) information 261, and the like are stored in the ROM 253.

The wireless profile 255 is information including settings such as identifying information (an SSID or the like) and authentication information (a password or the like) of the AP 102 connected through the wireless LAN interface 256. The wireless profile 255 is stored and managed by the CPU 252 running the program 254 included in the ROM 253. The MIB information 261 holds information that can be used by the Simple Network Management Protocol (SNMP), which is a standard for managing network devices and a protocol for network management. The MIB is defined by a tree structure. The MIB information 261 is associated with a unique Object IDentifier (OID). The printer 103 can then obtain the necessary information by specifying the OID when requesting the data using SNMP. Media Access Control (MAC) addresses associated with the wireless LAN interface 256 and the wired LAN interface 257 are stored in the MIB information 261 as management information.

The printer 103 has a MAC address randomization function. The MAC address randomization function is a function in which an apparatus periodically randomizes the MAC address. The printer 103 can enable or disable the MAC address randomization function by accepting configuration operations from the user, configuration instructions from the PC 101, and the like. A condition under which the MAC address is randomized by the MAC address randomization function will be called a “randomization condition” hereinafter. Specifically, the randomization condition is, for example, the printer 103 connecting to the access point 102. Note that the randomization condition may be another condition, such as a predetermined length of time passing, for example.

The MAC address randomization function is a function set by the Institute of Electrical and Electronics Engineers (IEEE). This function assigns a MAC address generated according to rules set by the IEEE to an apparatus. Hereinafter, a MAC address generated as a random value by the MAC address randomization function will be called a “random MAC address”. A MAC address not randomly generated by the MAC address randomization function, which has a fixed value that cannot be changed, will be called a “fixed MAC address”. If the MAC address randomization function is enabled, the printer 103 periodically randomizes the MAC addresses associated with the wireless LAN interface 256, the wired LAN interface 257, and the like of the printer 103. In other words, it is assumed that a random MAC address is used as the MAC address assigned to a communication unit of the printer 103. The printer 103 is also assumed to provide a random MAC address to external devices.

Note that the MAC address assigned to the communication unit of the printer 103 includes information indicating a random MAC address. A MAC address is expressed by alphanumeric characters and delimiters such as a colon, representing a 12-digit hexadecimal (e.g., 1A:2B:3C:4D:5E:6F). In the MAC address, the two alphanumeric characters separated by a delimiter are called octets. A MAC address in which the second bit is 1 when the value of the first octet (“1A” in the above example) is expressed as a binary number is defined by the IEEE as a random MAC address. The MAC address in which the second bit is 1 when the value of the first octet is expressed as a binary number, is, for example, a MAC address in which the value of the first octet ends with a value of 2, 6, A, or E. Furthermore, because the random MAC address is defined as described above, the fixed MAC address is a MAC address whose first octet value ends with a value aside from 2,6, A, or E.

The printer 103 changes the MAC address when connecting to the AP 102, for example. Specifically, for example, when changing the connection destination from the PC 101 to the AP 102 in a state where the printer 103 is directly connected to the PC 101 without going through the AP 102, the printer 103 changes the MAC address set in the wireless LAN interface 256.

In addition, when the MAC address associated with the wireless LAN interface 256, the wired LAN interface 257, or the like is randomized, the MAC address stored in the MIB information 261 is also randomized in conjunction therewith. The printer 103 can prevent the user’s location information from being leaked by periodically randomizing the MAC address set in the wireless LAN interface 256 in this manner. Additionally, assume, for example, that when the user connects the printer 103 to a public Wi-Fi hotspot and communicates, the communication is intercepted by a third party, and the MAC address becomes known to that third party. Even in such a case, if the printer 103 randomizes the MAC address at the time of the next communication, the third party that intercepted the communication cannot recognize that the same user is present. The user’s privacy can therefore be protected. Note that in the following descriptions, the MAC address associated with the wireless LAN interface 256 may simply be called the MAC address of the printer 103. In the present embodiment, the printer 103 has a plurality of modes for communicating using the wireless LAN interface 256. Specifically, for example, the printer 103 has a mode for communicating over a direct connection, an infrastructure connection mode, a wireless configuration mode, and the like. Tn the present embodiment, the printer 103 is assumed to have a plurality of MAC addresses corresponding to respective ones of these modes. Accordingly, it is assumed that when the MAC address randomization function is enabled, the plurality of MAC addresses corresponding to the modes are randomized when the randomization condition is met.

A unique SSID set uniquely for the printer 103 is also stored in the ROM 253. A unique SSID is defined for each manufacturer of the printer 103, each model of the printer 103, and the like. The wireless LAN interface 256 of the printer 103 can operate as an AP corresponding to this unique SSID. As such, the PC 101 can directly connect to the printer 103 operating as an AP, in the same manner as when connecting to the AP 102. Hereinafter, in the present embodiment, the unique SSID set uniquely for the printer 103 will be called the SSID of the printer 103.

The RAM 258 is constituted by a Static Random Access Memory (SRAM) or the like that requires a backup power source. Note that the RAM 258 holds data in a primary battery for data backup (not shown), and can therefore store important data such as program control variables in a non-volatile state. A memory area for storing the configuration information of the printer 103, the management data of the printer 103, and the like is also provided in the RAM 258. The RAM 258 is also used as a main memory and a working memory for the CPU 252.

The display device 259 displays data, various types of information such as notifications of the state of the printer 103, and the like through a user interface screen or the like, and is constituted by a liquid crystal panel (LCD), light-emitting diodes (LEDs), or the like, for example.

The input interface 260 is an interface for accepting data inputs, operational instructions, and the like from a user, and is constituted by a physical keyboard, buttons, a touch panel, or the like. Note that the display device 259 mentioned above and the input interface 260 may be the same configuration, with screen outputs and accepting operations by the user being implemented by the same configuration.

The printing unit 262 is configured to be capable of executing ink jet printing processing, for example, so that ink supplied from an ink tank is ejected from a print head and an image is recorded on a recording medium such as paper. Note that the printing unit 262 may be configured to be capable of executing other types of printing processing, such as electrophotographic printing. The printer 103 includes a printing control unit (not shown). The printing control unit applies various types of image processing, such as smoothing processing, print darkness correction processing, color correction, and the like, to the image data to be printed, and outputs the processed image data to the printing unit 262. The printing control unit can also periodically read out information on the printing unit 262 and update status information and the like stored in the RAM 258, including the remaining amount of ink in the ink tank, the state of the print head, and the like.

### Direct Connection Method

“Direct connection” refers to a form in which devices connect directly to each other (i.e., peer-to-peer) wirelessly, without going through an external device such as the AP 102 or the like. The direct connection will also be referred to as a peer-to-peer connection (P2P connection). The printer 103 can operate in a mode for communicating over a direct connection (a “direct connection mode”) as one connection mode. Wi-Fi communication includes a plurality of modes for communicating over a direct connection, such as a software AP mode, a Wi-Fi Direct (WFD) mode, and the like.

A mode in which a direct connection is made through WFD is called “WFD mode”. WFD is a standard developed by the Wi-Fi Alliance and is included in the IEEE 802.11 series communication standard. In WFD mode, a device to serve as a communication partner is searched for using a device search command, after which the roles of P2P group owner (GO) and P2P client are determined, and the remaining wireless connections are processed. “Group owner” corresponds to the parent station (parent device) in Wi-Fi, and the client corresponds to a child station (child device) in Wi-Fi. This role determination corresponds to GO Negotiation in P2P, for example. In WFD mode, the printer 103 is neither the parent station nor the child station before the roles have been determined. Specifically, one device among the devices that are to communicate issues the device search command, and searches for a device to connect to in WFD mode. When the other device, which is to serve as the communication partner, is discovered, the devices confirm information pertaining to the services and functions those respective devices can supply. Note that the confirmation of the device supply information is optional, and is not required. The device supply information confirmation phase corresponds to Provision Discovery in P2P, for example. Next, which device will serve as the P2P client and which will serve as the P2P group owner is determined by confirming this device supply information with each other. Once the client and the group owner have been determined, the devices exchange parameters for communicating through WFD. The remaining wireless connections and IP connections are processed between the P2P client and group owner on the basis of the exchanged parameters. Note that in WFD mode, the printer 103 may always operate as the GO, without performing the GO Negotiation described above. In other words, the printer 103 may operate in Autonomous GO mode, which is a WFD mode. A state in which the printer 103 is operating in WFD mode is, in other words, a state in which, for example, a connection through WFD is not established but the printer 103 is operating as the GO, a connection through WFD is established and the printer 103 is operating as the GO, or the like.

In the software AP mode, of the devices communicating (e.g., the PC 101 and the printer 103), one of the devices (e.g., the PC 101) functions as a client that has the role of requesting various types of services. The other device provides a Wi-Fi AP function by configuring software. The software AP corresponds to the parent station in Wi-Fi, and the client corresponds to the child station in Wi-Fi. In software AP mode, the client uses the device search command to search for a device that will serve as a software AP. Once a software AP is discovered, the remaining wireless connection processing (the establishment of a wireless connection and the like) is performed between the client and the software AP, after which IP connection processing (IP address allocation and the like) is performed. Note that commands, parameters, and the like sent and received when establishing a wireless connection between the client and the software AP may be any specified by the Wi-Fi standard, and will therefore not be described here.

In the present embodiment, when establishing and maintaining a direct connection, the printer 103 operates as the parent station in the network to which the printer 103 belongs. Note that “parent station” refers to a device that constructs a wireless network and is a device that provides child stations with the parameters used to connect to the wireless network. The parameters used to connect to the wireless network are parameters pertaining to a channel used by the parent station, for example. By receiving these parameters, a child station connects to the wireless network constructed by the parent station using the channel used by the parent station. In direct connection mode, the printer 103 operates as the parent station, and the printer 103 can therefore determine which frequency band and which channel to use in the communication performed in direct connection mode. In the present embodiment, the printer 103 is assumed to use a channel corresponding to the 2.4 GHz frequency band and a channel corresponding to the 5 GHz frequency band in the communication performed in direct connection mode.

### Wi-Fi Communication (Infrastructure Connection Mode)

The printer 103 of the present embodiment is assumed to operate in infrastructure connection mode in order to establish a connection using the infrastructure connection format in Wi-Fi communication (an infrastructure connection). Note that in the present embodiment, “infrastructure connection” refers to a format in which an external device that manages the network, such as the AP 102, operates as the parent station, and devices connect to each other wirelessly through the parent station. The printer 103 operating in infrastructure connection mode operates as a child device in the network to which the printer 103 belongs. In the infrastructure connection mode, the printer 103 and the PC 101 connect through the AP 102, and the printer 103 and the PC 101 can therefore communicate via the AP 102. Note that the channel used for communication in the infrastructure connection mode may be a frequency band other than 2.4 GHz (e.g., the 5.0 GHz band or the like). Note also that to communicate with the printer 103 via the AP 102, it is necessary for the PC 101 to recognize that the printer 103 belongs to the network formed by the AP 102 and to which the PC 101 belongs. Specifically, the PC 101 transmits a search signal via the AP 102 to the network to which the PC 101 belongs, and confirms the communication with the printer 103. In the present embodiment, a state in which the PC 101 and the printer 103 are simply connected to the same AP is assumed to be an infrastructure connection state. In other words, in the infrastructure connection state, the PC 101 and the printer 103 need only be connected to the same AP, and need not be aware that the partner device belongs to the network to which the device itself belongs.

### Wireless Configuration Mode

The printer 103 is capable of operating in a wireless configuration mode, which is a mode for executing wireless connection processing (described later). The trigger for the printer 103 to start operating in the wireless configuration mode may be, for example, the user pressing a wireless configuration mode button, or the printer 103 being started (powered on) for the first time after being shipped. The wireless configuration mode button may be a physical button provided in the printer 103, or may be a software button displayed by the printer 103 in the display device 259. When the printer 103 starts operating in the wireless configuration mode, Wi-Fi communication is enabled. Specifically, the printer 103 enables an AP within the printer 103 (a wireless configuration AP), which is specifically for the wireless configuration mode, as processing for enabling Wi-Fi communication. This enables the printer 103 to establish a direct connection with the PC 101 using Wi-Fi. Connection information (an SSID, a password, and the like) for connecting to the wireless configuration AP is assumed to be held in advance in the wireless configuration program 203 installed in the PC 101, and the PC 101 is assumed to have recognized the connection information for connecting to the wireless configuration AP. Accordingly, unlike the connection information of the AP enabled in the direct connection mode, it is assumed that the connection information for connecting to the wireless configuration AP cannot be changed by the user as desired. Note that an encryption mode need not be set for the wireless configuration AP, and thus a password may be unnecessary for connecting to the AP. Note also that in the wireless configuration mode, the printer 103 may connect to the PC 101 using WFD instead of normal Wi-Fi. In other words, the printer 103 may operate as the Group Owner and receive configuration commands from the PC 101 through WFD communication.

### Wireless Configuration Processing

In the present embodiment, the PC 101 executes the configuration causing the printer 103 to operate in the infrastructure connection mode (wireless configuration) using wireless communication with the printer 103. The wireless configuration processing according to the present embodiment is executed through wireless communication and is therefore also called “cableless setup” (CLS). Note, however, that the wireless configuration processing may be executed through wired communication. The printer 103 executes wireless configuration instruction processing while operating in the wireless configuration mode, which is a mode for executing the wireless configuration processing. The PC 101 performs the wireless configuration processing when the wireless configuration program 203 is running. The wireless configuration program 203 is an application program for configuring the AP to which the printer 103 is to connect, as well as causing the printer 103 to print image data, document data, and the like within the PC 101.

Note that the wireless configuration program 203 may include other functions in addition to the function for executing the wireless configuration processing, which is processing for configuring the AP to which the printer 103 is to connect by transmitting a wireless configuration instruction (configuration command) to the printer 103, the function for causing the printer 103 to execute printing, and the like. For example, if the printer 103 includes a scanning function, the wireless configuration program 203 may include a function for scanning a document set in the printer 103, a function for configuring other settings of the printer 103, a function for confirming the state (status) of the printer 103, and the like. Additionally, although the wireless configuration program 203 includes a function for executing the wireless configuration processing, the wireless configuration program 203 may lack other functions, such as the function for causing the printer 103 to execute printing. The function for causing the printer 103 to print is, specifically, a function for transmitting, to the printer 103, a print job for causing the printer 103 to print. Additionally, the function for causing the printer 103 to scan a document that has been set is, specifically, a function for transmitting a scan job to the printer 103 for causing the printer 103 to execute a scan. The function for confirming the state of the printer 103 is, specifically, a function for obtaining information indicating the status of the printer 103 from the printer 103 and displaying that information. The wireless configuration program 203 is assumed to be an application program.

The following assumes that the processing executed by the wireless configuration program 203 is implemented by the CPU 201 reading out the wireless configuration program 203 stored in the ROM 202 into the RAM 206 and executing the wireless configuration program 203. When the PC 101 connects the AP 102 and the printer 103 and causes the printer 103 to operate in the infrastructure connection mode, the PC 101 wirelessly transmits, to the printer 103, a wireless configuration instruction (an infrastructure configuration command) for causing the printer 103 to operate in the infrastructure connection mode. The wireless configuration instruction includes information pertaining to the AP 102, for example. The information pertaining to the AP 102 includes, for example, the SSID of the AP 102, a password for connecting to the AP 102, information pertaining to the frequency band used by the AP 102, and the like. Through the wireless configuration processing, after a infrastructure connection is established between the PC 101 and the printer 103 through Wi-Fi, the PC 101 and the printer 103 can communicate over the established connection. Specifically, for example, the PC 101 can transmit a print job for causing the printer 103 to print, or a scan job for causing the printer 103 to perform a scan, to the printer 103 over the established connection. When an infrastructure connection is established, the printer 103 can communicate with the Internet via the AP 102. For example, the printer 103 can receive notifications of updates for the device from a specific server, download print data, or upload information on the printer 103.

In this manner, the PC 101 can communicate with the printer 103 via the AP 102 by executing the wireless configuration processing using the wireless configuration program 203. In the wireless configuration processing, the PC 101 searches for the printer 103 via the AP 102 after transmitting the wireless configuration instruction to the printer 103. The PC 101 uses an identifier such as the MAC address to identify whether the printer 103 that transmitted the wireless configuration instruction and the printer 103 discovered via the AP 102 are the same device. Specifically, when the PC 101 establishes a temporary connection with the printer in the wireless configuration mode, the PC 101 obtains the MAC address of the printer 103 from the printer 103. Then, after transmitting the wireless configuration instruction, the PC 101 searches for the printer 103 connected to the AP 102, and obtains the MAC address of the printer 103 from the printer 103 again. The PC 101 then confirms whether the MAC address of the printer obtained when the temporary connection was established with the printer in the wireless configuration mode matches the MAC address of the printer obtained via the AP 102. If the MAC addresses match, the PC 101 recognizes that the printer 103 that transmitted the wireless configuration instruction and the printer 103 discovered via the AP 102 are the same device. In other words, the PC 101 can confirm that communication with the printer 103 via the AP 102 is possible.

However, the printer 103 may have a MAC address randomization function as described above. In such a case, the printer 103 receives the wireless configuration instruction from the PC 101, and randomizes the MAC address of the printer 103 when connecting to the AP 102. In this situation, the MAC address of the printer 103 obtained when the PC 101 established the temporary connection with the printer in the wireless configuration mode will not match the MAC address of the printer 103 obtained via the AP 102. The PC 101 therefore cannot recognize whether the printer 103 has successfully connected to the AP 102.

It is conceivable to register the original MAC address, another identifier, or the like in the MIB information 261 as an identifier for the PC 101 to identify the printer 103, for example. However, MIB is a standard for managing network devices, and the MIB information 261 is information that can be referenced by a third party. Accordingly, registering fixed information through which the individual can be identified in the MIB fails to protect the individual’s privacy, which is the purpose of the MAC address randomization to begin with.

Accordingly, in the present embodiment, in the communication system including the PC 101 and the printer 103, the PC 101 and the printer 103 operate as follows. The PC 101 establishes a P2P connection with the printer 103, which operates in the wireless configuration mode. Then, when the P2P connection is established, the PC 101 makes a request to the printer 103 for the MAC address of the printer 103. The printer 103 starts operating in the wireless configuration mode. Then, upon receiving the request from the PC 101 for the MAC address of the printer 103, the printer 103 transmits the MAC address of the printer 103 to the PC 101. Upon receiving the request for the MAC address of the printer 103 from the PC 101, the printer 103 controls the MAC address of the printer 103 not to be randomized, on the basis of the MAC address randomization function being enabled and a specific state being effective.

Such a configuration makes it possible to prevent the MAC address of the printer 103 from being randomized during the period from when the PC 101 first requests the MAC address from the printer 103 to when the PC 101 requests the MAC address again for identification. In other words, when the PC 101 and the printer 103 having the MAC address randomization function communicate, the randomization of the MAC address of the printer 103 can be controlled as appropriate.

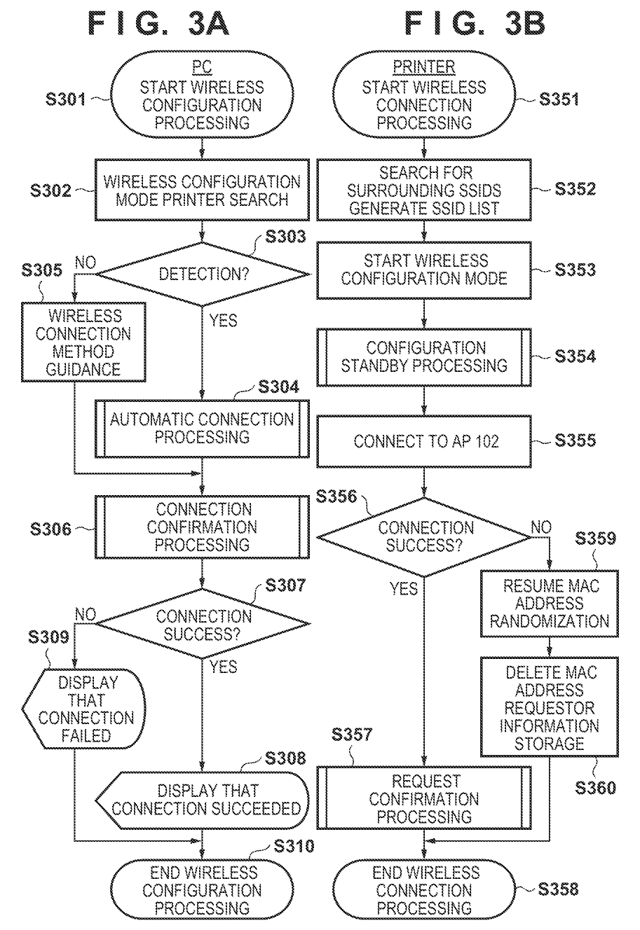

Processing performed by the PC 101 and the printer 103 according to the present embodiment will be described hereinafter. First, the descriptions will refer to FIG. 3A. FIG. 3A is a flowchart illustrating an example of the wireless configuration processing executed by the PC 101 according to the present embodiment. This flowchart is implemented by the CPU 201 reading out the wireless configuration program 203 stored in the ROM 202 into the RAM 206 and executing the wireless configuration program 203. It is assumed here that the PC 101 is already connected to the external AP 102. It is also assumed that the PC 101 stores the SSID and password of the AP 102 in the wireless profile 204.

In step S301, when an instruction to launch the wireless configuration program 203 (a user operation) is received through the display device 208, the PC 101 starts the wireless configuration instruction processing. Note that the PC 101 may accept the instruction to launch the wireless configuration program 203 through the input interface 209, for example.

In step S302, the PC 101 searches for the printer 103 operating in the wireless configuration mode. Specifically, the PC 101 searches for a beacon emitted by the printer 103 operating in the wireless configuration mode. The beacon emitted by the printer 103 operating in the wireless configuration mode includes the SSID of the printer 103 as information. The SSID of the printer 103 includes a name indicating that the printer 103 operates in the wireless configuration mode. For example, the SSID “TS8xxx_SETUP_mmnnn” will be described as an example. The SSID “TS8xxx_SETUP_mmnnn” indicates that the printer 103 named “TS8xxx” is an AP operating in the wireless configuration mode using the “SETUP” character string. Furthermore, considering cases where a plurality of printers 103 of the same model are present, an identification number “mmnnn” (called a “serial number” hereinafter) of the printer 103, which differs from printer 103 to printer 103, is included in the SSID.

In step S303, the PC 101 determines whether the printer 103 operating in the wireless configuration mode has been detected. If the PC 101 determines that the printer 103 has been detected, the sequence moves to step S304. However, if the PC 101 determines that the printer 103 could not be detected, the sequence moves to step S305.

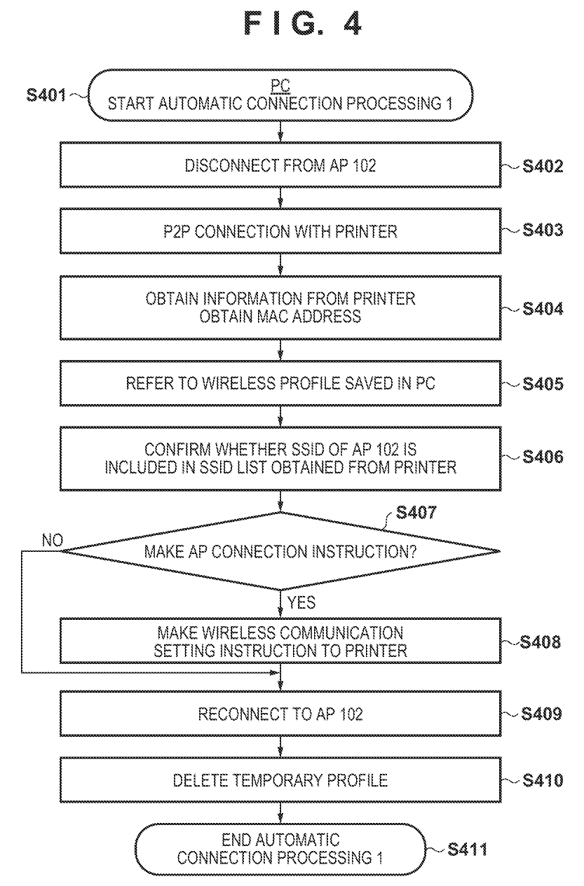

In step S304, the PC 101 executes automatic connection processing for connecting the printer 103 to the AP 102. Here, the descriptions will refer to FIG. 4. FIG. 4 is a flowchart illustrating an example of automatic connection processing 1 executed by the PC 101 in step S304 of FIG. 3A.

In step S401, the PC 101 starts the automatic connection processing 1. In step S402, the PC 101 terminates the wireless connection between the PC 101 and the AP 102.

In step S403, the PC 101 makes a P2P connection to the printer 103 operating in the wireless configuration mode. Specifically, the PC 101 connects the wireless LAN interface 211 to the wireless configuration AP corresponding to the SSID of the printer 103. In other words, a direct connection that does not go through the AP 102 is established between the PC 101 and the printer 103 in the processing of step S403.

When a direct connection has been established in S403, in step S404, the PC 101 requests information from the printer 103. The PC 101 then obtains a response to the request from the printer 103. Here, the information requested by the PC 101 for the printer 103 includes an SSID list. The SSID list indicates the APs that the printer 103 has searched for. This will be described in detail later.

In step S404, the PC 101 makes the request for the MAC address of the printer 103, which is the identification information of the printer 103, to the printer 103 at a first timing. Specifically, the PC 101 obtains the MAC address of the printer 103 from the MIB information 261 by specifying the OID in the MIB information 261 using SNMP. Accordingly, the MAC address of the printer 103 requested at the first timing corresponds to the MAC address of the printer 103 transmitted from the printer 103 at the first timing. By designating the OID, the PC 101 can efficiently obtain the MAC address of the printer 103. The communication in this processing is executed over the direct connection established in step S403. Specifically, the MAC address of the printer 103 obtained here is assumed to be, for example, a MAC address corresponding to the wireless configuration mode. MAC addresses corresponding to other modes need not be obtained. In this processing, the PC 101 is also assumed to obtain a device ID from the printer 103. The device ID is an ID shared by each model of the printer 103, i.e., an ID corresponding to the model of the printer 103.

In step S405, the PC 101 refers to the wireless profile 204. Then, the PC 101 obtains the wireless profile 204 including the SSID of the AP 102 which was connected at the start of the automatic connection processing 1 and for which the wireless connection was terminated in step S402.

In step S406, the PC 101 confirms whether the SSID of the AP 102 obtained from the wireless profile 204 in step S405 is included in the SSID list obtained from the printer 103 in step S404.

In step S407, the PC 101 determines whether to instruct the printer 103 to perform the wireless configuration. If the PC 101 determines to make the instruction, the sequence moves to step S408. However, if the PC 101 determines not to make the instruction, the sequence moves to step S409. Specifically, upon confirming in step S405 that the SSID of the AP 102 is included in the SSID list, the PC 101 determines to instruct the wireless configuration to be performed. If the SSID of the AP 102 is confirmed to not be included in the SSID list in step S405, the PC 101 determines not to instruct the wireless configuration to be performed.

In step S408, the PC 101 makes the wireless configuration instruction to the printer 103. Specifically, in step S408, the PC 101 transmits information pertaining to the AP 102 (the SSID of the AP 102 and the password of the AP 102) to the printer 103. In other words, the PC 101 instructs the printer 103 to connect to the AP 102.

In step S409, the PC 101 terminates the P2P connection between the PC 101 and the printer 103, and reconnects to the AP 102. The wireless profile 204 of the AP 102 is stored in the ROM 202 of the PC 101. Accordingly, in step S409, the PC 101 can reconnect to the AP 102 without the user needing to re-enter a password or the like.

In step S410, if a wireless profile temporarily remains in the P2P connection with the printer 103, the PC 101 deletes that wireless profile. The processing in step S410 is performed to avoid situations where the wireless profile for a connection not intended by the user remains.

In step S411, the PC 101 ends the automatic connection processing 1.

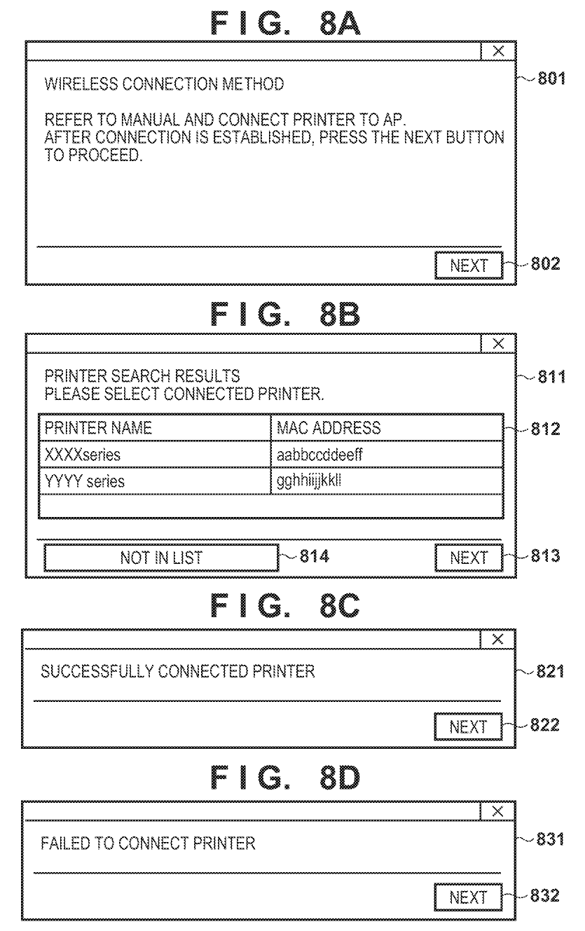

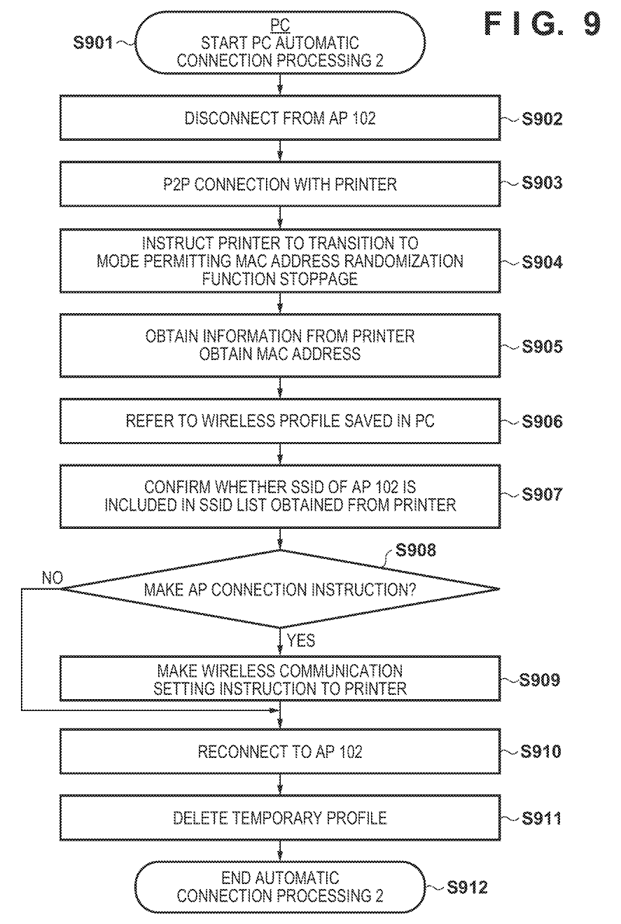

The descriptions will again refer to FIG. 3A. In step S305, the PC 101 displays a wireless connection method guidance screen 801 on the display device 208. Here, the descriptions will refer to FIG. 8A. FIG. 8A is a diagram illustrating an example of the guidance screen 801 displayed on the display device 208 by the PC 101 in step S305. The guidance screen 801 displays a message prompting the user to refer to the manual and wirelessly connect the printer 103 to the AP 102. If the printer 103 in the wireless configuration mode has not been detected (No in step S303), the PC 101 cannot transmit the wireless configuration instruction to the printer 103. Accordingly, the PC 101 notifies the user to prompt the user to operate the printer 103 so as to connect to the AP 102. The guidance screen 801 also displays a message prompting the user to press a button 802 when the printer 103 has been wirelessly connected to the AP 102. The guidance screen 801 also displays the button 802. The button 802 is an interface capable of accepting a user instruction to advance the processing to step S306. When the button 802 is pressed, the PC 101 moves the sequence to step S306.

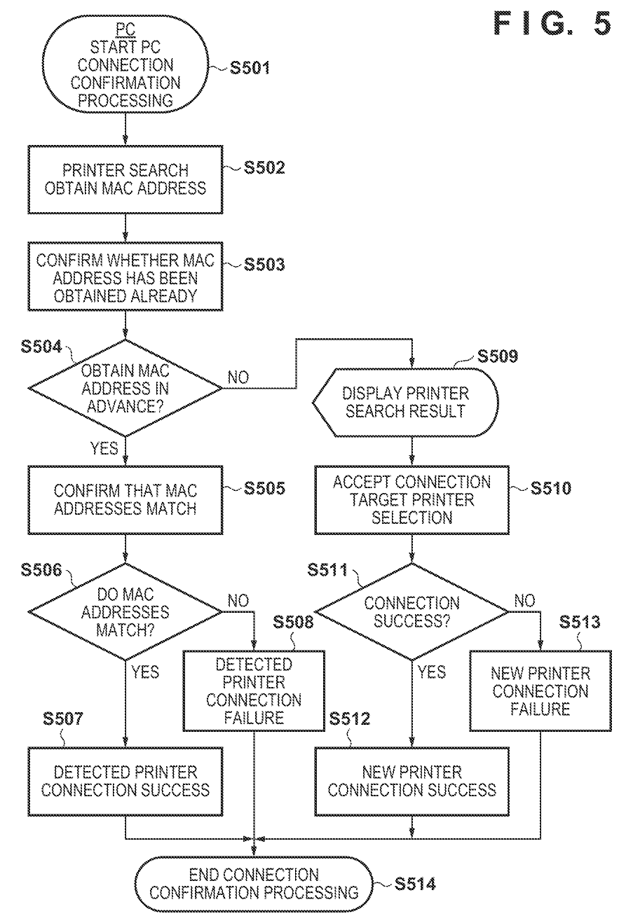

In step S306, the PC 101 executes connection confirmation processing to confirm whether the printer 103 has connected to the AP 102. Here, the descriptions will refer to FIG. 5. FIG. 5 is a flowchart illustrating an example of the automatic connection processing 1 performed by the PC 101 in step S306 of FIG. 3A.

In step S501, the PC 101 starts the connection confirmation processing. In step S502, the PC 101 searches for the printer 103 via the AP 102. Specifically, the PC 101 first obtains the MAC address, the device ID, and the IP address corresponding to the infrastructure connection mode from all the printers 103 belonging to the network formed by the AP 102. All the printers 103 belonging to the network formed by the AP 102 are discovered as a result. The PC 101 then identifies, from the list of discovered printers, one printer having a device ID that matches the device ID obtained in step S404. In other words, the PC 101 identifies, from the list of discovered printers, one printer of the model corresponding to the device ID obtained in step S404. Then, via the AP 102, the PC 101 transmits a request for the MAC address corresponding to the wireless configuration mode to the printer 103 identified as described above, using the MAC address and the IP address corresponding to the infrastructure connection mode. The PC 101 then obtains the MAC address corresponding to the wireless configuration mode as the MAC address of the printer 103. In other words, the PC 101 makes the request for the MAC address of the printer 103 to the printer 103 at a second timing that is after the first timing. Specifically, the PC 101 obtains the MAC address associated with the wireless LAN interface 256 from the MIB information 261 by designating the OID using SNMP. Accordingly, the MAC address of the printer 103 requested at the second timing corresponds to the MAC address of the printer 103 transmitted from the printer 103 at the second timing. Through this, the PC 101 can efficiently obtain the MAC address of the printer 103.

In step S503, the PC 101 confirms whether the MAC address of the printer 103 has been obtained through the processing of step S404.

In step S504, using the confirmation result from step S503, the PC 101 determines whether the MAC address of the printer 103 has been obtained in the processing of step S404. If the PC 101 determines that the MAC address has been obtained, the sequence moves to step S505. However, if the PC 101 determines that the MAC address has not been obtained, the sequence moves to step S509.

In step S505, the PC 101 confirms whether the MAC addresses match. Specifically, the PC 101 compares the MAC address obtained in step S502 with the MAC address obtained in step S404 and confirms whether the MAC addresses match.

In step S506, the PC 101 determines whether the MAC address obtained in step S502 matches the MAC address obtained in step S404. If the PC 101 determines that the MAC addresses match, the sequence moves to step S507. However, if the PC 101 determines that the MAC addresses do not match, the sequence moves to step S508. Note that if the printer 103 that transmitted the MAC address to the PC 101 in step S502 and the printer 103 that transmitted the MAC address to the PC 101 in step S404 are the same, the MAC address randomization function of the printer 103 is stopped, and thus the printer 103 determines that the MAC addresses match in this determination. Additionally, if the printer 103 that transmitted the MAC address to the PC 101 in step S502 and the printer 103 that transmitted the MAC address to the PC 101 in step S404 are not the same, the MAC addresses are determined not to match in this determination. Note that the comparison in step S505 may be made using a MAC address corresponding to another mode instead of the MAC address corresponding to the wireless configuration mode. In this case, in step S502, step S404, and the like, MAC addresses corresponding to other modes are obtained.

In step S507, the PC 101 determines that the printer 103 has successfully established a wireless infrastructure connection with the AP 102 and determines that the connection is successful. If the connection is determined to be successful, the PC 101 may execute processing for installing a printer driver corresponding to the printer 103. Specifically, for example, an installer for installing a printer driver corresponding to the printer 103 may be installed, the printer driver may be installed using the installer, or the like.

In step S508, the PC 101 determines that the printer 103 could not establish a wireless infrastructure connection with the AP 102 and determines that the connection has failed. If the connection is determined to have failed, the PC 101 does not execute processing for installing a printer driver corresponding to the printer 103.

In this manner, in the wireless configuration processing, the PC 101 can determine whether the printer 103 has successfully connected to the AP 102 by comparing the two MAC addresses obtained.

However, if the PC 101 determines in step S504 that the MAC address set in the wireless LAN interface 256 in the processing of step S404 has not been obtained, the MAC address cannot be compared as in step S506. In other words, because the PC 101 cannot confirm whether the printer 103 has successfully connected to the AP 102 using the MAC address, the processing from step S509 on is executed.

In step S509, the PC 101 displays a printer search result screen 811 on the display device 208. Here, the descriptions will refer to FIG. 8B. FIG. 8B is a diagram illustrating an example of the search result screen 811 displayed by the PC 101 on the display device 208 in step S509 of FIG. 5. The search result screen 811 displays a list display part 812, and a message prompting the user to select a printer connected to the AP 102 from the list display part 812.

For example, when the PC 101 searches for printers via the AP 102 in the list display part 812 in step S502, the device name and the MAC address of the discovered printers are displayed as a list from which a printer can be selected by the user. For example, if the user has followed the guidance in the guidance screen 801 displayed by the PC 101 in step S305 and the printer 103 has been successfully connected to the AP 102, the printer 103 is displayed in the list display part 812. Note that in the present embodiment, for example, the PC 101 displays the search result screen 811 even if the printer 103 cannot be discovered via the AP 102 in step S502. In this case, the list of the device names and the MAC addresses of the printers are not displayed in the list display part 812.

The search result screen 811 also displays a button 813 and a button 814. The button 813 is an interface capable of accepting a user instruction to advance the processing to step S512. The button 814 is an interface capable of accepting a user instruction to advance the processing to step S513.

In step S510, the PC 101 accepts a user selection of the printer 103 to be connected. The PC 101 accepts a user selection of the printer 103 connected to the AP 102 from the list display part 812 of the search result screen 811 displayed in step S509.

In step S511, the PC 101 determines whether the button 813 or the button 814 has been pressed. If the PC 101 determines that the button 813 has been pressed, the sequence moves to step S512. However, if the PC 101 determines that the button 814 has been pressed, the sequence moves to step S513.

In step S512, the PC 101 determines that the printer 103 has successfully established a wireless infrastructure connection with the AP 102 and determines that the connection is successful.

In step S513, the PC 101 determines that the printer 103 could not establish a wireless infrastructure connection with the AP 102 and determines that the connection has failed. In other words, the PC 101 determines whether the printer 103 has successfully connected to the AP 102 on the basis of a user operation made in the search result screen 811.

In step S514, the PC 101 ends the connection confirmation processing. Once the connection confirmation processing ends, the PC 101 moves the sequence to step S307 in FIG. 3A. Although the present embodiment describes the PC 101 as displaying the search result screen 811 in step S509 even if not even a single printer is searched out in step S502, the configuration is not limited thereto. For example, if not even a single printer is searched out in step S502, the PC 101 may move the sequence to step S513 without displaying the search result screen 811 in step S509.

The descriptions will again refer to FIG. 3A. In step S307, the PC 101 determines whether the printer 103 has successfully connected to the AP 102. In other words, the PC 101 determines whether the printer 103 has successfully established a wireless infrastructure connection with the AP 102. If the PC 101 determines that the connection has been established successfully, the sequence moves to step S308. However, if the PC 101 determines that the connection has failed, the sequence moves to step S309. Specifically, the PC 101 makes this determination on the basis of the result of the connection confirmation processing in step S306. If the sequence has passed through the processing in step S507 or step S512, the PC 101 determines that the connection has been established successfully, whereas if the sequence has passed through the processing in step S508 or step S513, the PC 101 determines that the connection has failed.

In step S308, the PC 101 displays a connection success screen 821 on the display device 208. FIG. 8C illustrates an example of the connection success screen 821 displayed by the PC 101 on the display device 208 in step S308. The connection success screen 821 displays a message indicating that the printer 103 has connected to the AP 102, and a button 822. The button 822 is an interface capable of accepting a user instruction to end the wireless configuration processing. When the button 822 is pressed, the PC 101 moves the sequence to step S310 and ends the wireless configuration processing.

In step S309, the PC 101 displays a connection failure screen 831 on the display device 208. FIG. 8D is a diagram illustrating an example of the connection failure screen 831 displayed on the display device 208 by the PC 101 in step S309. The connection failure screen 831 displays a message indicating that the printer 103 was unable to connect to the AP 102, and a button 832. The button 832 is an interface capable of accepting a user instruction to end the wireless configuration processing. When the button 832 is pressed, the PC 101 moves the sequence to step S310 and ends the wireless configuration processing.

In this manner, the PC 101 controls the display of the screen displayed on the display device 208 on the basis of the result of the connection confirmation processing. If the printer 103 has successfully connected to the AP 102, the PC 101 notifies the user of that the connection is successful through the connection success screen 821. However, if the printer 103 has failed to connect to the AP 102, the PC 101 notifies the user of that the connection has failed through the connection failure screen 831. Such a notification enables the user to recognize the result of the printer 103 connecting to the AP 102 (whether the connection is successful).

Next, the descriptions will refer to FIG. 3B. FIG. 3B is a flowchart illustrating an example of the wireless connection processing executed by the printer 103. This flowchart is implemented by the CPU 252 reading out the program 254 stored in the ROM 253 into the RAM 258 and executing the program 254.

In step S351, the printer 103 starts the wireless configuration processing in response to the trigger described above.

In step S352, the printer 103 searches for surrounding SSIDs before transitioning to the wireless configuration mode. In other words, the printer 103 searches for surrounding APs. The printer 103 then generates the SSID list including the detected SSIDs.

In step S353, the printer 103 starts operating in the wireless configuration mode. Specifically, the printer 103 causes the wireless LAN interface 256 to operate as a wireless configuration AP. By starting to operate as a wireless configuration AP, the printer 103 can make a P2P connection with the PC 101.

Although the present embodiment describes the printer 103 as searching for surrounding SSIDs before starting the wireless configuration mode, the configuration is not limited thereto. For example, the printer 103 may search for surrounding SSIDs after starting the wireless configuration mode. Additionally, the printer 103 may search for surrounding SSIDs upon receiving an instruction to search for surrounding SSIDs around the printer 103 from the PC 101.

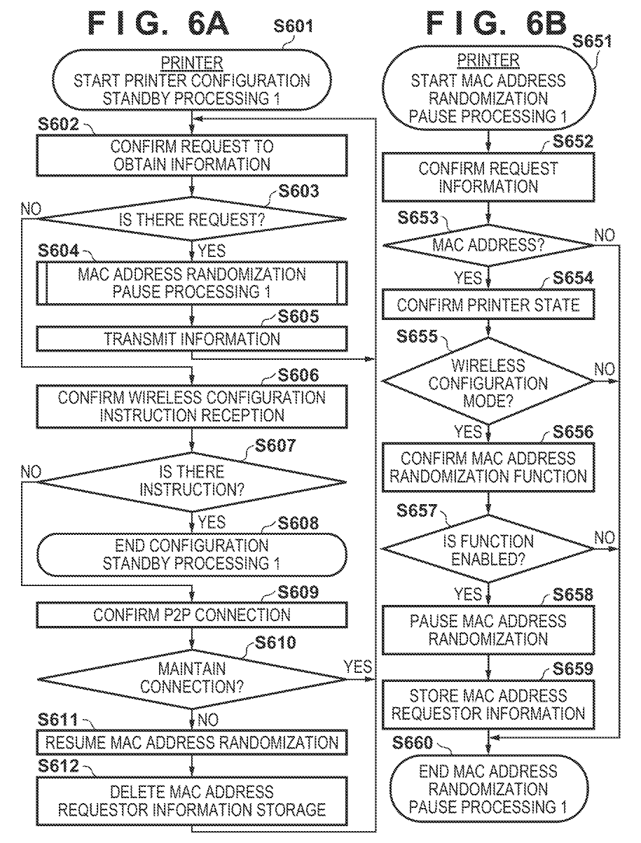

In step S354, the printer 103 executes configuration standby processing. Here, the descriptions will refer to FIG. 6A. FIG. 6A is a flowchart illustrating an example of configuration standby processing 1 performed by the printer 103 in step S354 of FIG. 3B.

In step S601, the printer 103 starts the configuration standby processing 1. In step S602, the printer 103 confirms whether a request for information has been received from the PC 101.

In step S603, the printer 103 determines whether the request for information has been received from the PC 101. If the printer 103 determines that the request has been received, the sequence moves to step S604. However, if the printer 103 determines that the request has not been received, the sequence moves to step S606. Note that receiving the request for information from the PC 101 means that the printer 103 receives, from the PC 101, information for the PC 101 to request (obtain) information from the printer 103.

In step S604, the printer 103 executes MAC address randomization pause processing 1. Here, the descriptions will refer to FIG. 6B. FIG. 6B is a flowchart illustrating an example of the MAC address randomization pause processing 1 performed by the printer 103 in step S604 of FIG. 6A. This processing is executed on the basis of the request for information having been received from the PC 101.

In step S651, the printer 103 starts the MAC address randomization pause processing 1.

In step S652, the printer 103 confirms the information requested by the PC 101.

In step S653, the printer 103 determines whether the information requested by the PC 101 is the MAC address of the printer 103. If the printer 103 determines that the information is the MAC address, the sequence moves to step S654. However, if the printer 103 determines that the information is not the MAC address, the sequence moves to step S660.

In step S654, the printer 103 confirms whether the state of the printer 103 is the wireless configuration mode.

In step S655, the printer 103 determines whether the state of the printer 103 is the wireless configuration mode. In other words, the printer 103 determines whether the state of the printer 103 is a specific state. If the printer 103 determines that the state is the wireless configuration mode, the sequence moves to step S656. However, if the printer 103 determines that the state is not the wireless configuration mode, the sequence moves to step S660.

In step S656, the printer 103 confirms whether the MAC address randomization function of the printer 103 is enabled.

In step S657, the printer 103 determines whether the MAC address randomization function of the printer 103 is enabled. If the printer 103 determines that the function is enabled, the sequence moves to step S656. However, if the printer 103 determines that the function is disabled, the sequence moves to step S660.

In step S658, the printer 103 temporarily disables the MAC address randomization function. In other words, the printer 103 stops the MAC address randomization for the printer 103. Accordingly, the MAC address of the printer 103 stored in the MIB information 261 in the ROM 253 is not randomized, even if the randomization condition is satisfied. In other words, the printer 103 controls the MAC address of the printer 103 not to be randomized even if the randomization condition is satisfied. Note that in this processing, the printer 103 may control all the plurality of MAC addresses of the printer 103 not to be randomized even if the randomization condition is satisfied. The printer 103 may also control only at least one MAC address among the plurality of MAC addresses not to be randomized even if the randomization condition is satisfied. The printer 103 may also control the MAC address other than at least one MAC address of the plurality of MAC addresses to be randomized on the basis of the randomization condition being satisfied. Specifically, for example, the printer 103 may control only the MAC address corresponding to the wireless configuration mode not to be randomized even if the randomization condition is satisfied, and may control the MAC address corresponding to a mode other than the wireless configuration mode (a mode for communicating over a direct connection, the infrastructure connection mode, or the like) to be randomized on the basis of the randomization condition being satisfied.

In this manner, in the present embodiment, when the printer 103 receives the request for the MAC address of the printer 103 from the PC 101 at the first timing, the printer 103 controls the MAC address of the printer 103 not to be randomized on the basis of the following condition. In the present embodiment, the condition is that the printer 103 is in a state of operating in the wireless configuration mode (Yes in step S655) and that the MAC address randomization function of the printer 103 is enabled (Yes in step S657). Through this, if the PC 101 makes a request for the MAC address of the printer 103 again, the printer 103 can transmit the MAC address of the same printer 103.

In step S659, the printer 103 stores the identification information (e.g., the MAC address) of the PC 101 that requested the MAC address in a memory such as the RAM 258.

In step S660, the printer 103 ends the MAC address randomization pause processing 1. Although the present embodiment describes the printer 103 as making the determinations in the MAC address randomization pause processing in the order of step S653, step S655, and step S657, the configuration is not limited thereto, and the determinations may be made in any order.

In step S605, the printer 103 performs information transmission processing in response to a request from the PC 101. For example, if the printer 103 receives a request for information including the MAC address from the PC 101, the printer 103 transmits the list of SSIDs generated in step S352 and the MAC address of the printer 103 to the PC 101. As described above, if the printer 103 has executed step S658, the MAC address randomization function is disabled. Accordingly, until the printer 103 re-enables the MAC address randomization function, the MAC address transmitted to the PC 101 by the printer 103 matches the MAC address held by the printer 103 in the MIB information 261.

In step S606, the printer 103 confirms whether the wireless configuration instruction has been received from the PC 101.

In step S607, the printer 103 determines whether the wireless configuration instruction from the PC 101 has been received. If the printer 103 determines that the wireless configuration instruction has been received, the sequence moves to step S608, where the configuration standby processing 1 in FIG. 6A ends. However, if the printer 103 determines that the wireless configuration instruction has not been received, the sequence moves to step S609.

In step S609, the printer 103 confirms whether the P2P connection between the printer 103 and the PC 101 is still active.

In step S610, the printer 103 determines whether the P2P connection between the printer 103 and the PC 101 is still active. If the printer 103 determines that the connection is still active, the sequence moves to step S602. However, if the printer 103 determines that the connection is no longer active, the sequence moves to step S611.

In step S611, the printer 103 enables the MAC address randomization function, if the MAC address randomization function was disabled in the processing of step S658. In other words, if the P2P connection between the printer 103 and the PC 101 has been terminated, the printer 103 controls the MAC address of the printer 103 to be randomized again, without receiving the wireless configuration instruction. Such control makes it possible to prioritize protecting the privacy of the user in situations where it is not necessary to disable the randomization of the MAC address of the printer 103.

In step S612, if the identification information (e.g., the MAC address) of the PC 101 is stored in a memory such as the RAM 258, the printer 103 deletes the identification information (e.g., the MAC address) of the PC 101. The printer 103 then returns the sequence to step S602.

Although the present embodiment describes the printer 103 as making the determinations in the configuration standby processing 1 in the order of step S603, step S607, and step S610, the configuration is not limited thereto, and the determinations may be made in any order. Additionally, in the present embodiment, the MAC address randomization pause processing 1 is executed on the basis of the request for information being received from the PC 101, but the configuration is not limited thereto. For example, the MAC address randomization pauses processing 1 may be executed on the basis of the printer 103 starting operations in the wireless configuration mode in step S353.

The descriptions will now return to FIG. 3B. Once the configuration standby processing ends in step S354, the printer 103 executes the processing of step S355. In step S355, the printer 103 executes processing for connecting to the AP 102 on the basis of the wireless configuration instruction from the PC 101. Specifically, the printer 103 attempts to connect to the AP 102 using the information pertaining to the AP 102 (the SSID and password of the AP 102) included in the wireless configuration instruction received from the PC 101.

In step S356, the printer 103 determines whether the connection to the AP 102 is successful. If the printer 103 determines that the connection is successful, the sequence moves to step S357. However, if the printer 103 determines that the connection has failed, the sequence moves to step S359.

In step S357, the printer 103 executes request confirmation processing, then moves to step S358, where the processing of FIG. 3B ends. Request confirmation processing will be described in detail later.

In step S359, if the MAC address randomization function was temporarily disabled in the processing of step S658, the printer 103 enables the MAC address randomization function. In other words, the printer 103 resumes the MAC address randomization. That is, if the printer 103 was unable to connect to the AP 102, the printer 103 controls the MAC address of the printer 103 to be randomized again. If the printer 103 has failed to connect to the AP 102 instructed by the PC 101, the printer 103 does not accept further requests for MAC addresses from the PC 101 via the AP 102. Accordingly, the printer 103 can prioritize protecting the privacy of the user by controlling the MAC address of the printer 103 to be randomized again in step S359.

In step S360, if the identification information (e.g., the MAC address) of the PC 101 has been stored in a memory such as the RAM 258, the printer 103 deletes the identification information (e.g., the MAC address) of the PC 101.

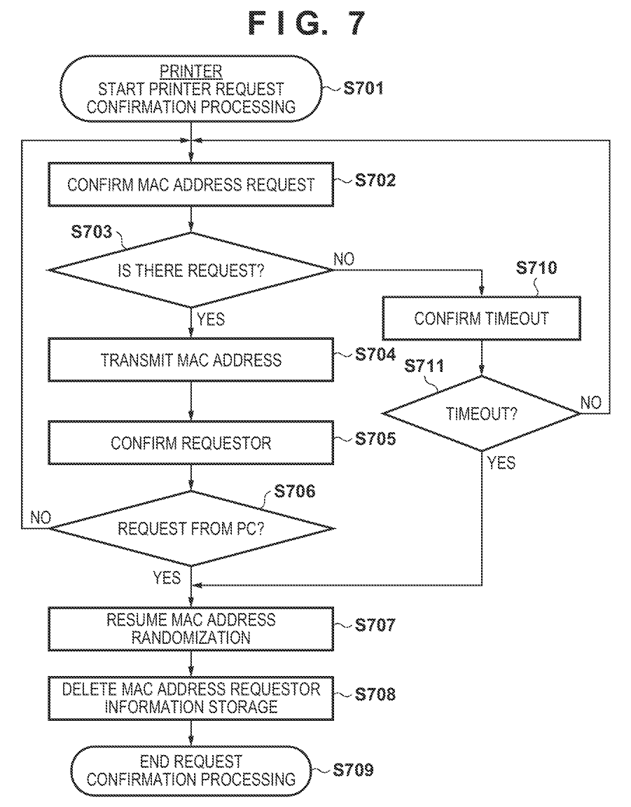

Here, the descriptions will refer to FIG. 7. FIG. 7 is a flowchart illustrating an example of the request confirmation processing performed by the printer 103 in step S357 of FIG. 3B.

In step S701, the printer 103 starts the request confirmation processing. In step S702, the printer 103 confirms whether a request to obtain the MAC address of the printer 103 has been received from the PC 101.

In step S703, the printer 103 determines whether a request for the MAC address of the printer 103 has been received from the PC 101. If the printer 103 determines that the request has been received, the sequence moves to step S704. However, if the printer 103 determines that the obtainment request has not been received, the sequence moves to step S710.

In step S704, the printer 103 transmits the MAC address of the printer 103 to the PC 101. In other words, when the printer 103 has connected to the AP 102 and the MAC address of the printer 103 has been requested by the PC 101 at the second timing, the printer 103 transmits the MAC address of the printer 103 to the PC 101 via the AP 102.

In step S705, the printer 103 confirms the requestor of the MAC address of the printer 103. Specifically, the printer 103 obtains the identification information (e.g., the MAC address) of the requestor of the MAC address of the printer 103.

In S706, the printer 103 determines whether the requestor of the MAC address is the PC 101. If the printer 103 determines that the requestor is the PC 101, the sequence moves to step S707. However, if the printer 103 determines that the requestor is not the PC 101, the sequence moves to step S702. Specifically, the printer 103 compares the identification information obtained in step S705 with the identification information of the PC 101 stored in the processing of step S659 and determines whether the items of identification information match. Through this, the printer 103 can identify whether the PC 101 that has requested the MAC address of the printer 103 via the AP 102 and the PC 101 that was connected at the timing of step S659 are the same PC.

In step S707, the printer 103 enables the MAC address randomization function that was temporarily disabled in the processing of step S658. In other words, the printer 103 resumes the MAC address randomization. That is, when the printer 103 transmits the MAC address of the printer 103 to the PC 101 via the AP 102, the printer 103 controls the MAC address of the printer 103 to be randomized again. Such control makes it possible to prevent the MAC address randomization function of the printer 103 from remaining disabled. This processing is executed on the basis of a determination of “Yes” being made in step S703, the transmission of the MAC address in step S704, a determination of “Yes” being made in step S706, and the like.

In step S708, the printer 103 deletes the identification information (e.g., the MAC address) of the PC 101 that was stored in the memory such as the RAM 258. Then, in step S709, the printer 103 ends the request confirmation processing.

In step S710, the printer 103 confirms the length of time that has passed since the MAC address request confirmation was performed. In other words, the printer 103 sets a timeout in the processing of accepting the request for the MAC address.

In step S711, the printer 103 determines whether the time that has passed since the MAC address request confirmation was performed has exceeded a predetermined threshold time set in advance. In other words, the printer 103 determines a timeout in the MAC address request confirmation. If the printer 103 determines that the threshold time has been exceeded, the sequence moves to step S707. However, if the printer 103 determines that the threshold time has not been exceeded, the sequence moves to step S702. The predetermined threshold time is set to, for example, a length of time statistically calculated to not place stress on the user.

In this manner, the printer 103 starts the MAC address request confirmation in step S702, and when the predetermined threshold time has passed, moves the sequence to step S707, where the MAC address randomization function is enabled (the MAC address randomization is resumed). In other words, if, after connecting to the AP 102, the printer 103 has not received a request for the MAC address of the printer 103 from the PC 101, the printer 103 controls the MAC address of the printer 103 to be randomized again. Such control makes it possible to prevent the MAC address randomization function from being disabled.

The descriptions will again refer to FIG. 3B. In step S358, the printer 103 ends the wireless configuration processing.

Although the present embodiment describes the printer 103 as disabling the MAC address randomization function in step S658, the configuration is not limited thereto. As described above, the MAC address of the printer 103 stored in the MIB information 261 in the ROM 253 is randomized in conjunction with the MAC address randomization function of the printer 103. Accordingly, in step S658, the printer 103 may control the MAC address of the printer 103 stored in the MIB information 261 in the ROM 253 to not be randomized. In other words, the configuration may be such that in step S658, the printer 103 stops updating the MIB information 261. In this case, the MAC address randomization function of the printer 103 remains enabled, which makes it easier to protect the privacy of the user. In the configuration in which the printer 103 stops updating the MIB information 261 in step S658, the printer 103 resumes updating the MIB information 261 in the processing of steps S359, S611, and S707.

Additionally, although the present embodiment describes the printer 103 as re-enabling the MAC address randomization function in the processing of steps S359, S611, and S707, control such as that described hereinafter may be performed, for example.

The configuration may be such that, for example, the printer 103 re-enables the MAC address randomization function in the processing of steps S359, S611, and S707, and randomizes the MAC address of the printer 103 stored in the MIB information 261 in the ROM 253. Such a configuration makes it possible to protect the privacy of the user even when the printer 103 temporarily disables the MAC address randomization function.

Additionally, the configuration may be such that, for example, in the processing of steps S359, S611, and S707, the printer 103 determines whether the MAC address randomization function is disabled before re-enabling the MAC address randomization function. For example, if in step S359 the MAC address randomization is determined to be disabled, the printer 103 may enable the MAC address randomization and move the sequence to step S360. However, for example, if the printer 103 determines in step S359 that the MAC address randomization is not disabled, the sequence may move to step S358. Additionally, for example, if the printer 103 determines in step S611 that the MAC address randomization is disabled, the printer 103 may enable the MAC address randomization and move the sequence to step S612. However, for example, if the printer 103 determines in step S611 that the MAC address randomization is not disabled, the sequence may move to step S602. Additionally, for example, if the printer 103 determines in step S707 that the MAC address randomization is disabled, the printer 103 may enable the MAC address randomization and move the sequence to step S708. However, for example, if the printer 103 determines in step S707 that the MAC address randomization is not disabled, the sequence may move to step S709. Such a configuration makes it possible for the printer 103 to skip processing when the MAC address randomization is determined to not be disabled.

Furthermore, although the present embodiment describes the printer 103 as temporarily disabling the MAC address randomization function when the state of the printer 103 is the wireless configuration mode, the configuration is not limited thereto. For example, the printer 103 may temporarily disable the MAC address randomization function under the condition that the state of the printer 103 is one in which the connection is configured through another methods, such as Wi-Fi Easy Connect (WEC).

According to the embodiment described thus far, when, after establishing a P2P connection with the PC 101, the printer 103 receives a request for the MAC address of the printer 103 from the PC 101, the printer 103 controls the MAC address of the printer 103 not to be randomized when the following condition is satisfied. In the present embodiment, the condition is that the printer 103 is operating in the wireless configuration mode and that the MAC address randomization function of the printer 103 is enabled. Such a configuration makes it possible to prevent the MAC address of the printer 103 from being randomized during the period from when the PC 101 first requests the MAC address to when the PC 101 requests the MAC address again for identification. Accordingly, when the PC 101 performs wireless configuration for the printer 103 having a MAC address randomization function, the printer 103 can be identified. Furthermore, the printer 103 enables the MAC address randomization function after the wireless configuration, and thus the privacy of the user can continue to be protected.

Although the foregoing has described a configuration in which the MAC address of the printer 103 is obtained in step S404 through the direct connection established in step S403, the configuration is not limited thereto. For example, the configuration may be such that the MAC address of the printer 103 is obtained from the beacon emitted by the printer 103 operating in the wireless configuration mode, which is obtained in step S302. In this configuration, the MAC address of the printer 103 transmitted from the printer 103 at the first timing corresponds to the MAC address of the printer 103 transmitted from the printer 103 by the beacon at the first timing. Note that the MAC address of the printer 103 included in the beacon is the MAC address corresponding to the wireless configuration mode, and MAC addresses corresponding to other modes are not included in the beacon. Accordingly, in this configuration, the comparison in step S505 is made using the MAC address corresponding to the wireless configuration mode. Furthermore, in this configuration, even if the printer 103 makes a determination of “Yes” in step S603, the sequence moves to step S605 without executing step S604. Then, the processing for pausing the MAC address randomization (the processing of step S658) is executed before the direct connection is established in step S403, on the basis of the printer 103 having started operating in the wireless configuration mode. Furthermore, in the processing described above as processing for referring to the MAC address of the printer 103 obtained in step S404 (steps S503 to S506), the MAC address of the printer 103 obtained from the beacon is referred to instead of the MAC address of the printer 103 obtained in step S404.

### Second Embodiment

A second embodiment will be described hereinafter, focusing on differences from the first embodiment. In the first embodiment, the printer 103 temporarily disables the MAC address randomization function when the state of the printer 103 is the wireless configuration mode. However, if a request for the MAC address from an external device other than the PC 101 is made, it is possible that the printer 103 will disable the MAC address randomization function. Accordingly, in the present embodiment, the printer 103 temporarily disables the MAC address randomization function when in a permissive mode that permits the MAC address randomization function to be disabled. Then, when the PC 101 makes a request for the MAC address of the printer 103 to the printer 103, the PC 101 issues an instruction to enter the permissive mode. Such a configuration makes it possible to prevent the printer 103 from stopping the MAC address randomization function even when only a MAC address from an external device different from the PC 101 is requested. In other words, the printer 103 can stop the MAC address randomization function at a more appropriate timing.

First, refer to FIG. 9. FIG. 9 is a flowchart illustrating an example of automatic connection processing 2 executed by the PC 101 in step S304 of FIG. 3A, according to the present embodiment.

The processing of steps S901 to S903 in FIG. 9 is the same as the processing of steps S401 to S403 in FIG. 4, and will therefore not be described.

In step S904, the PC 101 instructs the printer 103 to transition to a permissive mode that permits the MAC address randomization function to be disabled (called a “transition instruction” hereinafter). In the present embodiment, the printer 103 can be set the permissive mode (a permissive state) in which the MAC address randomization function is permitted to be disabled, for example. For example, when the state of the printer 103 is the permissive mode, the printer 103 stops the MAC address randomization function when the MAC address of the printer 103 is requested. In other words, the transition instruction can also be said to be an instruction for the printer 103 to stop the MAC address randomization. On the other hand, if the state of the printer 103 is not the permissive mode, the printer 103 does not disable the MAC address randomization function even if the MAC address of the printer 103 is requested. Accordingly, in the present embodiment, the PC 101 makes the transition instruction to transition the printer 103 to the permissive mode before requesting the MAC address of the printer 103 from the printer 103 at the first timing (step S905).

The processing of steps S905 to S912 in FIG. 9 is the same as the processing of steps S404 to S411 in FIG. 4, and will therefore not be described here.

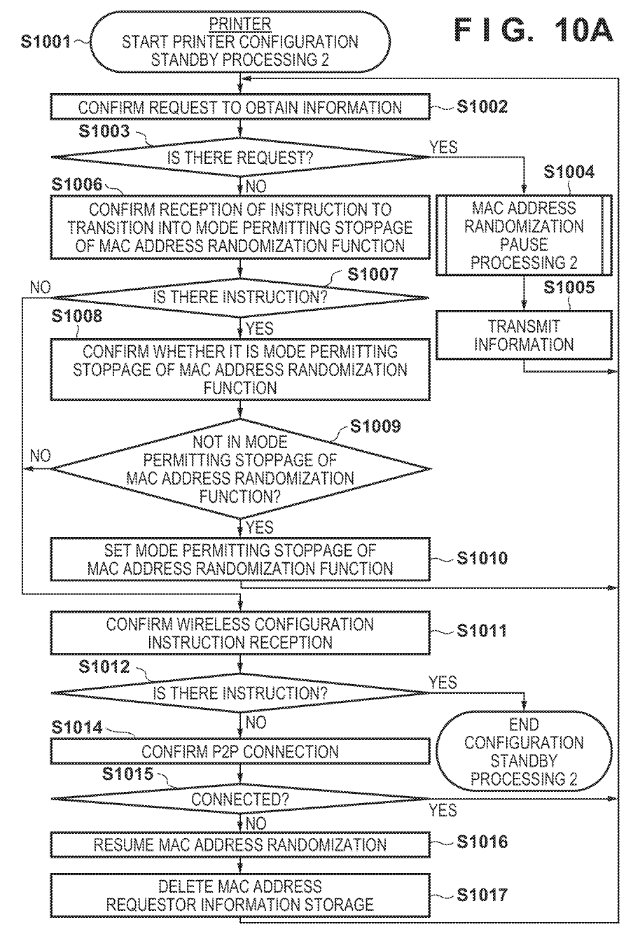

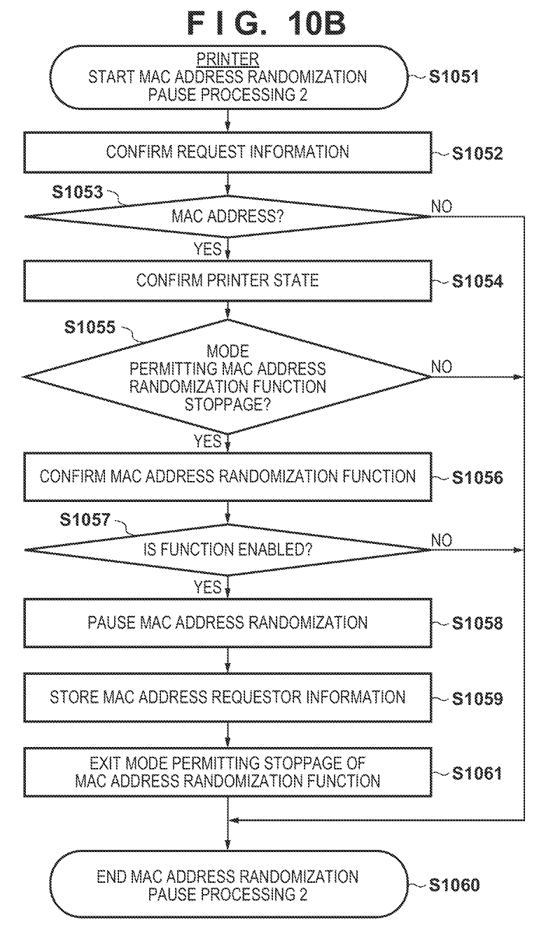

Next, the descriptions will refer to FIG. 10A. FIG. 10A is a flowchart illustrating an example of configuration standby processing 2 executed by the printer 103 in step S354 of FIG. 3B, according to the present embodiment.

Note that steps S1001 and S1002 in FIG. 10A are the same as steps S601 and S602 in FIG. 6A, and will therefore not be described here.

In step S1003, the printer 103 determines whether the request for information has been received from the PC 101. If the printer 103 determines that the request has been received, the sequence moves to step S1004. However, if the printer 103 determines that request has not been received, the sequence moves to step S1006.

In step S1004, the printer 103 executes MAC address randomization pause processing 2. The MAC address randomization pauses processing 2 will be described in detail later. Step S1005 is the same as the processing of step S605 and will therefore not be described.

In step S1006, the printer 103 confirms whether the transition instruction has been received from the PC 101.

In step S1007, the printer 103 determines whether the transition instruction has been received from the PC 101. If the printer 103 determines that the transition instruction has been received, the sequence moves to step S1008. However, if the printer 103 determines that the transition instruction has not been received, the sequence moves to step S1011.

In step S1008, the printer 103 confirms whether the state of the printer 103 is the permissive mode.

In step S1009, the printer 103 confirms whether the state of the printer 103 is the permissive mode. In other words, the printer 103 determines whether the state of the printer 103 is a specific state. If the printer 103 determines that the state is not the permissive mode, the sequence moves to step S1010. However, if the printer 103 determines that the state is the permissive mode, the sequence moves to step S1011.

In step S1010, the printer 103 sets the state of the printer 103 to the permissive mode on the basis of the transition instruction having been received from the PC 101.

The processing of steps S1011 to S1017 is similar to that of steps S607 to S612 and will therefore not be described.

Here, the descriptions will refer to FIG. 10B. FIG. 10B is a flowchart illustrating an example of the MAC address randomization pause processing 2 executed by the printer 103 in step S1004 of FIG. 10A. Note that steps S1051 to S1053 in FIG. 10B are the same as the processing of steps S651 to S653 in FIG. 6B, and will therefore not be described here.

In step S1054, the printer 103 confirms whether the state of the printer 103 is the permissive mode.

In step S1055, the printer 103 confirms whether the state of the printer 103 is the permissive mode. In other words, the printer 103 determines whether the state of the printer 103 is a specific state. If the printer 103 determines that the state is the permissive mode, the sequence moves to step S1056. However, if the printer 103 determines that the state is not the permissive mode, the sequence moves to step S1060. Steps S1056 and S1057 are the same as steps S656 and S657 and will therefore not be described here.

In step S1058, the printer 103 temporarily disables the MAC address randomization function. In this manner, in the present embodiment, when the printer 103 receives the request for the MAC address of the printer 103 from the PC 101 at the first timing, the printer 103 controls the MAC address of the printer 103 not to be randomized on the basis of the following condition. In the present embodiment, the condition is that the printer 103 is in the permissive mode that permits the MAC address randomization function to be disabled (“Yes” in step S1055) and that the MAC address randomization function of the printer 103 is enabled (“Yes” in step S1057). Taking the state of the printer 103 being the permissive mode as the condition makes it possible to prevent the MAC address randomization function from stopping when only the MAC address of the printer 103 is requested by an external device different from the PC 101.

In step S1059, the printer 103 stores the identification information (e.g., the MAC address) of the PC 101 that requests the MAC address in a memory such as the RAM 258.

In step S1061, the printer 103 exits the permissive mode. This makes it possible to prevent the MAC address randomization function from being disabled when the printer 103 has received a request for the MAC address of the printer 103 from an external device different from the PC 101.

Although the present embodiment describes the printer 103 as making the determinations in the order of step S1003, step S1007, step S1009, step S1012, and step S1015, the configuration is not limited thereto, and the determinations may be made in any order. Additionally, although the printer 103 makes the determinations in the order of step S1053, step S1055, and step S1057, the configuration is not limited thereto, and the determinations may be made in any order.

Furthermore, in the present embodiment, the sequence moves to step S1056 when the printer 103 determines in step S1055 that the state of the printer 103 is the permissive mode, but the configuration is not limited thereto. For example, if the printer 103 determines in step S1055 that the state of the printer 103 is the permissive mode, the printer 103 may determine whether the state of the printer 103 is the wireless configuration mode. The sequence may then move to step S1056 if the printer 103 determines that the state is the wireless configuration mode. The sequence may also move to step S1060 if the printer 103 determines that the state is not the wireless configuration mode.

According to the embodiment described thus far, the printer 103 stops the MAC address randomization function upon receiving a request for the MAC address of the printer 103 in the permissive mode in which the MAC address randomization function can be disabled. Additionally, when the PC 101 makes a request for the MAC address of the printer 103, the PC 101 transmits a transition instruction to the printer 103 for transitioning to the permissive mode. Such a configuration makes it possible to prevent the printer 103 from disabling the MAC address randomization function when the printer 103 receives a request for the MAC address from an external device different from the PC 101 before receiving the transition instruction from the PC 101. In other words, the printer 103 can disable the MAC address randomization function of the printer 103 at a more appropriate timing.

According to the present disclosure, a technique can be provided for appropriately controlling MAC address randomization of a communication apparatus when an information processing apparatus and a communication apparatus having a MAC address randomization function communicate.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-164103, filed September 20, 2024, which is hereby incorporated by reference herein in its entirety.

What is claimed is:

1. A communication system comprising an information processing apparatus and a communication apparatus,
the communication apparatus comprising at least one memory and at least one processor which function as:
a first transmitting unit configured to transmit a MAC address of the communication apparatus at a first timing;
a control unit configured to execute specific control based on a specific function that randomizes the MAC address of the communication apparatus according to a specific condition being enabled and the communication apparatus being in a specific mode for performing wireless configuration of the communication apparatus, the specific control controlling the communication apparatus to not randomize the MAC address of the communication apparatus even when the specific condition is satisfied; and
a second transmitting unit configured to transmit the MAC address of the communication apparatus at a second timing after the specific control is executed, and
the information processing apparatus comprising at least one memory and at least one processor which function as:
a third transmitting unit configured to transmit information for performing the wireless configuration of the communication apparatus over a connection between the communication apparatus in the specific mode and the information processing apparatus; and
an executing unit configured to execute processing that is based on the MAC address of the communication apparatus transmitted at the first timing and the MAC address of the communication apparatus transmitted at the second timing.

2. The communication system according to claim 1,
wherein processing of transmitting the MAC address of the communication apparatus at the first timing is processing of the communication apparatus operating in the specific mode transmitting a beacon including the MAC address of the communication apparatus.

3. The communication system according to claim 1,
wherein processing of transmitting the MAC address of the communication apparatus at the first timing is processing of transmitting the MAC address of the communication apparatus over a connection between the communication apparatus operating in the specific mode and the information processing apparatus.

4. The communication system according to claim 1,
wherein processing of transmitting the MAC address of the communication apparatus at the second timing is processing of transmitting the MAC address of the communication apparatus after the wireless configuration of the communication apparatus is performed, based on the information for performing the wireless configuration of the communication apparatus.

5. The communication system according to claim 4,
wherein the information for performing the wireless configuration of the communication apparatus is information regarding an external access point external to the communication apparatus and external to the information processing apparatus, and
the processing of transmitting the MAC address of the communication apparatus at the second timing is processing of transmitting the MAC address of the communication apparatus via the external access point after the communication apparatus connects to the external access point, based on the information for performing the wireless configuration of the communication apparatus.

6. The communication system according to claim 1,
wherein the specific control is executed based on the communication apparatus starting to operate in the specific mode.

7. The communication system according to claim 1,
wherein the specific control is executed based on predetermined communication being performed over a connection between the communication apparatus operating in the specific mode and the information processing apparatus.

8. The communication system according to claim 1,
wherein the communication apparatus has a plurality of MAC addresses as the MAC address of the communication apparatus, and
the specific control is processing of controlling the communication apparatus to not randomize the MAC address even if at least one MAC address among the plurality of MAC addresses satisfies the specific condition, and controlling the communication apparatus to randomize the MAC address based on a MAC address aside from the at least one MAC address among the plurality of MAC addresses satisfying the specific condition.

9. The communication system according to claim 1,
wherein the communication apparatus has a plurality of MAC addresses as the MAC address of the communication apparatus, and
the specific control is processing of controlling the communication apparatus to not randomize the MAC address even if all of the plurality of MAC addresses satisfy the specific condition.

10. The communication system according to claim 1,
wherein the communication apparatus has a plurality of MAC addresses as the MAC address of the communication apparatus, and
the MAC address of the communication apparatus transmitted at the first timing and the MAC address of the communication apparatus transmitted at the second timing are MAC addresses, among the plurality of MAC addresses, that correspond to the specific mode.

11. The communication system according to claim 1,
wherein the at least one memory and the at least one processor of the communication apparatus further function as:
a stopping unit configured to stop the specific control after the MAC address of the communication apparatus is transmitted at the second timing.

12. The communication system according to claim 1,
wherein the MAC address of the communication apparatus is transmitted at the second timing based on a request for the MAC address of the communication apparatus being received from the information processing apparatus, and
the at least one memory and the at least one processor of the communication apparatus further function as:
a stopping unit configured to stop the specific control, based on the request for the MAC address of the communication apparatus not being received.

13. The communication system according to claim 1,
wherein the at least one memory and the at least one processor of the communication apparatus further function as:
a stopping unit configured to stop the specific control based on the wireless configuration that is based on the information for performing the wireless configuration of the communication apparatus not being executed.

14. The communication system according to claim 1,
wherein the at least one memory and the at least one processor of the communication apparatus further function as:
a stopping unit configured to stop the specific control based on the connection between the communication apparatus in the specific mode and the information processing apparatus being terminated without the information for performing the wireless configuration of the communication apparatus being received.

15. The communication system according to claim 1,
wherein processing that is based on the MAC address of the communication apparatus transmitted at the first timing and the MAC address of the communication apparatus transmitted at the second timing is processing of comparing the MAC address of the communication apparatus transmitted at the first timing with the MAC address of the communication apparatus transmitted at the second timing.

16. The communication system according to claim 15,
wherein the at least one memory and the at least one processor of the information processing apparatus further function as:
a processing unit configured to execute processing for installing a corresponding driver in the communication apparatus, based on the MAC address of the communication apparatus transmitted at the first timing and the MAC address of the communication apparatus transmitted at the second timing matching.

17. The communication system according to claim 1,
wherein the at least one memory and the at least one processor of the communication apparatus further function as:
a configuring unit configured to enable or disable the specific function, based on an operation from a user or an instruction from the information processing apparatus.

18. The communication system according to claim 1,
wherein the communication apparatus is a printing apparatus.

19. A control method for a communication system including an information processing apparatus and a communication apparatus, the control method comprising:
the communication apparatus transmitting a MAC address of the communication apparatus at a first timing;
the communication apparatus executing specific control based on a specific function that randomizes the MAC address of the communication apparatus according to a specific condition being enabled and the communication apparatus being in a specific mode for performing wireless configuration of the communication apparatus, the specific control controlling the communication apparatus to not randomize the MAC address of the communication apparatus even when the specific condition is satisfied; and
the communication apparatus transmitting the MAC address of the communication apparatus at a second timing after the specific control is executed;
the information processing apparatus transmitting information for performing the wireless configuration of the communication apparatus over a connection between the communication apparatus in the specific mode and the information processing apparatus; and
the information processing apparatus executing processing that is based on the MAC address of the communication apparatus transmitted at the first timing and the MAC address of the communication apparatus transmitted at the second timing.

20. A communication apparatus capable of communicating with an information processing apparatus, the communication apparatus comprising at least one memory and at least one processor which function as:
a first transmitting unit configured to transmit a MAC address of the communication apparatus at a first timing;
a control unit configured to execute specific control based on a specific function that randomizes the MAC address of the communication apparatus according to a specific condition being enabled and the communication apparatus being in a specific mode for performing wireless configuration of the communication apparatus, the specific control controlling the communication apparatus to not randomize the MAC address of the communication apparatus even when the specific condition is satisfied;
a receiving unit configured to receive information for performing the wireless configuration of the communication apparatus over a connection between the communication apparatus in the specific mode and the information processing apparatus; and
a second transmitting unit configured to transmit the MAC address of the communication apparatus at a second timing after the specific control is executed.
